(19) United States
(12) Patent Application Publication
(10) Pub. No.: US 2008/0173112 A1
(43) Pub. Date: Jul. 24, 2008

(54) Detent device

(75) Inventors: Terukazu Hiroe, Aichi (JP); Masahiko Miyata, Aichi (JP); Seiji Ishigaki, Aichi (JP)

Correspondence Address: MORGAN LEWIS & BOCKIUS LLP, 1111 PENNSYLVANIA AVENUE NW, WASHINGTON, DC, 20004, US

(73) Assignee: Kabushiki Kaisha Tokai Rika Denki Seisakusho, Aichi (JP)

(21) Appl. No.: 12/007,989

(22) Filed: Jan. 17, 2008

(30) Foreign Application Priority Data
Jan. 18, 2007 (JP) 2007-009213

(51) Int. Cl. G05G 5/06

(52) U.S. Cl. 74/10.41

(57) ABSTRACT

A shaft of an operating member is provided with a rotation detention receiving member having a substantially V-shaped concave portion. A detention giving unit includes a coil spring of a steel wire and a pressing member and presses the pressing member against the concave portion of the rotation detention receiving member to give rotation detention thereto. An electromagnet is arranged on a device base. A rotary encoder is attached to the shaft. Of the rotation detention receiving member and the detention giving unit, as regards the rotation detention receiving member is rotatable integrally to the operating member; and as regards the detention giving unit, while the electromagnet is de-energized, it is rotated integrally to the operating member whereas while the electromagnet is de-energized, it is attracted by the electromagnet so that it is fixed in a non-rotating state.

### BACKGROUND OF THE INVENTION

This invention relates to a detent device for giving detention to the operation of an operating member.

Traditionally, a rotary switch device used in various controls of a motor vehicle, like the switch device disclosed in JP-A-5-94922, has a detent mechanism including a detent face alternately having hills and valleys formed on the inner face of a case, a coil spring provided on the rotor side within the case and a ball urged to come in contact with the detent face by the coil spring.

According to the detent mechanism having such a structure, where an operator rotates an operating knob to make a switching operation, with the rotation of the rotor, the ball climbs over the hill to move to the valley, and falls in the valley. Namely, before and after the ball climbs over the hill, the force of feedback given to the operating knob changes. Thus, a click feeling is given for the rotation of the operating knob (operating member).

The clicking mechanism disclosed in JP-A-5-94922 presents a problem that the rotation angle (hereinafter referred to as a clocking angle) given the clock when the operating member is rotated is limited by the arranging pitch of the hills and the valleys on the clicking face. In order to solve this problem, the clocking device having the structure shown in FIG. 4 has been proposed.

Referring to FIG. 4, in a device base 2 attached at an appropriate position on e.g. the rear side of an instrument panel 1, a shaft 3 is rotatably supported. To the end (upper end in the figure) of the shaft 3 projecting on the front side of the instrument panel 1, an operating member 4 is attached in such a manner that it rotates integrally to the shaft 3. Further, to the lower end of the shaft 3, the disk 5a of a rotary encoder 5 for detecting the rotary position of the operating member 4 is attached in such a manner that it rotates integrally to the shaft 3.

On the side of the lower end of the shaft 3, an attracted member 6 is attached in such a manner that it rotates integrally to the shaft 3. On the upper surface of the attracted member 6, an attracted body 6a of a magnetic sheet is attached. Above the attracted body 6a, an electromagnet 7 is provided so that it can rotate irrespectively of the shaft 3 and move vertically by a minor distance. Between the electro magnet 7 and the device base 2, flat springs 8, 8 of synthetic resin are provided. The one end of the flat springs 8, 8 is attached to the device base 2 whereas the other end thereof is attached to the electromagnet 7. These flat springs 8, 8 serve to give detention to the rotation of the shaft 3. An appropriate operated object is additionally provided on the shaft 3 or coupled therewith.

In the structure as shown, the electromagnet 7 is normally electrically de-energized. When the operating member 4 is rotated by an operator, the shaft 3, disk 5a and attracted member 6 rotate integrally. When the operating member 4 is rotated by a predetermined angle, the rotary encoder 5 detects this predetermined angle. On the basis of this, a control unit (not shown) energizes the electromagnet 7. Then, the electromagnet 7 and the attracted body 6a are attracted by each other so that the electromagnet 7, attracted body 6a, shaft 3 and operating member 4 are integrated. Thus, when the operator further rotates the operating member 4 from this state, the other end of the flat springs 8, 8 will be elastically deformed in a rotating direction to generate spring force in a restoring direction so that the operator undergoes the rotating detention. When the electromagnet is de-energized, the operator does not undergo the rotation detention. Owing to a change in the rotation detention, a click feeling is given.

However, in this structure, since the flat springs 8, 8 of synthetic resin are employed, disadvantageously, it was difficult to set the shape giving a spring function and also select the material for setting the spring force. So, generally, it was difficult to set the click feeling. Further, it was also difficult to make fine setting such as the smoothness degree or abruptness degree of the sense of click.

### SUMMARY OF THE INVENTION

This invention has been accomplished in view of the circumstances described above. An object of this invention is to provide a detent device which can easily set a clicking angle and set the strength of the click feeling.

In accordance with this invention, a detent device comprises:

an operating member rotatably attached to a device base;

a rotation detention receiving member including a substantially V-shaped concave portion;

a detention giving unit that includes a coil spring and a pressing member which is pressed against the concave portion by spring force of the coil spring to give rotation detention thereto;

an electromagnet arranged on the device base;

a position detector that detects a rotary position of the operating member; and

a controller that controls energization of the electromagnet according to the rotary position of the operating member detected by the position detector,

wherein one of the rotation detention receiving member and the detention giving unit is rotatable integrally with the operating member, and the other of the rotation detention receiving member and the detention giving unit is rotatable integrally to the operation member when the electromagnet is de-energized, and is attracted by the electromagnet so as to be fixed in a non-rotating state when the electromagnet is energized.

In this configuration, when an operator rotates the operating member, one of the rotation detention receiving member and the detention giving unit rotates integrally to the operating member and while the electromagnet is de-energized, the other thereof also rotates integrally to the operating member. Therefore, while the electromagnet is de-energized, both rotation detention receiving member and the detention giving unit rotate with the rotation of the operating member. Thus, a detention feeling does not occur. Further, when the operating member reaches a predetermined rotary position, the predetermined rotary position is detected by the position detecting and the electromagnet is energized by the controller. Owing to this energizing, the other of the rotation detention receiving member and the detention giving unit is attracted by the electromagnet so that it is fixed in a non-rotating state. Then, the pressing member of the detention giving unit absolutely or relatively slides along the concave portion of the rotation detention receiving member against the spring force of the coil spring so that the spring force of the coil spring increases to strengthen the detention feeling. When the operating member further reaches a predetermined rotary position, the electromagnet is de-energized so that the detention feeling disappears. Thus, owing to an abrupt change in the detention feeling by the coil spring, the click feeling occurs.

In accordance with such a configuration, the clicking angle can be easily changed by changing the above predetermined angle. Further, the click feeling is given by the rotation detention receiving member having a concave portion and the detention giving unit having a coil spring and a pressing member, for pressing the pressing member against the concave portion of the rotation detection receiving member to give rotation detention thereto. The interval in which the click feeling is given and its strength can be easily set by appropriately selecting the coil spring and setting the sloping angle of the concave portion.

This invention facilitates setting of the clicking angle and various settings such as the strength of the click feeling.

### BRIEF DESCRIPTION OF THE DRAWINGS

FIG. 1 is a longitudinal sectional front view of the operating device of a heater control switch in a motor car according to an embodiment of this invention.

FIG. 2 is a transversal plan view of a detention giving unit.

FIG. 3A is a view showing the energizing/de-energizing pattern of an electromagnet and FIG. 3B is a view showing the changing manner in a detention feeling.

FIG. 4 is a view corresponding to FIG. 1, showing a prior art.

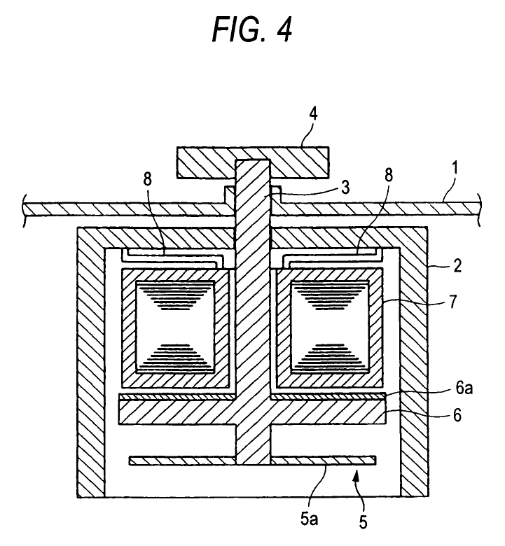

### DESCRIPTION OF PREFERRED EMBODIMENTS

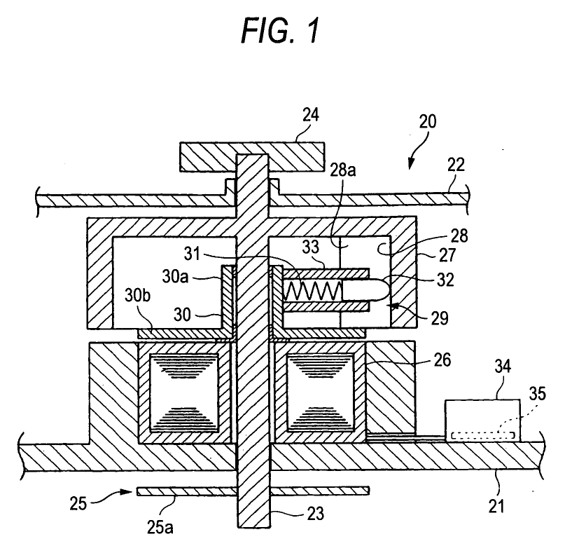

Now referring to FIGS. 1 to 3, an explanation will be given of an embodiment in which this invention is applied to e.g. an operating device of a heater control switch of a motor vehicle.

The device base 21 of an operating device 20 is attached at an appropriate position on the rear side of an instrument panel 22. In the device base 21, a shaft 23 is rotatably supported. To the end (upper end in the figure) of the shaft 23 projecting on the front side of the instrument panel 22, an operating member 24 is attached in such a manner that it rotates integrally to the shaft 23. Further, to the lower end of the shaft 23 projecting downward from the device base 21, the disk 25a of a rotary encoder 25 serving as a position detector for detecting the rotary position of the operating member 24 is attached in such a manner that it rotates integrally to the shaft 23.

To the device base 21, a nearly cylindrical electromagnet 26 is attached. The shaft 23 passes through the hollow part of the electromagnet 26.

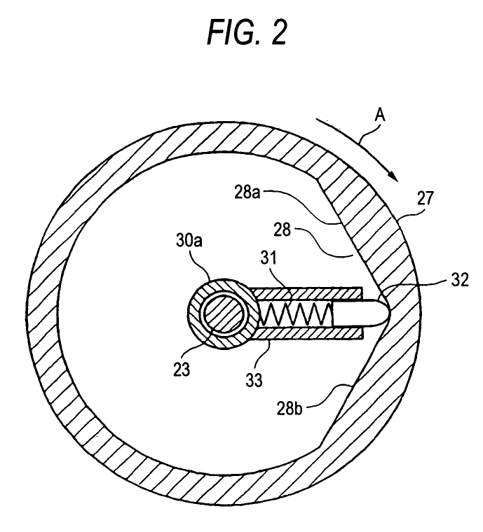

At the position above the electromagnet 26 of the shaft 23, a cylindrical rotation detention receiving member 27 is provided so that it can rotate integrally to the shaft 23. On the inner surface of the rotation detention receiving member 27, as shown in FIG. 2, a nearly V-shaped concave portion 28 is formed. This concave portion 28 forms a substantially V-shape by a slope 28a and a slope 28b.

At the shaft 23 portion within the rotation detention receiving member 27, a detention giving unit 29 is provided. The detention giving unit 29 includes an attracted member 30, a coil spring 31 of steel, a pressing member 32 and a guide cylinder 33.

The attracted member 30 is made of a magnetic material and includes a cylindrical part 30a and an attracted part 30b having a larger diameter formed at the lower end thereof. The attracted part 30b is opposite to the upper surface of the electromagnet 26 in the axial direction. The attracted member 30 is rotatably fit over the shaft 23.

The guide cylinder 33 is attached to the cylindrical part 30a of the attracted member 30 so that it extends in a centrifugal direction. Within the guide cylinder 33, at its tip side, the pressing member 32 is movably accommodated. Further, within the guide cylinder 33, the coil spring 31 is accommodated in a compressed state. The coil spring 31 is made of a steel wire such as a spring-use steel wire. By the spring force of the coil spring 31, as shown in FIG. 2, the pressing member 32 is pressed and urged toward the center of the valley of the concave portion 28.

A control unit 34 is provided on the device base 21. The control unit 34 includes a control circuit 35 serving as a controller for energizing/de-energizing the electromagnet 26 at a predetermined rotary position. The control unit 34 also includes a setting device (not shown) for arbitrarily setting the energizing/de-energizing pattern (predetermined rotary position) by a manual operation. Namely, the energizing/de-energizing pattern for the electromagnet 26 in the control circuit 35 can be changed on the basis of the operation of the setting device. In this case, the predetermined rotary position is set at the angle of 15° (energizing in a certain range of the angle of 15° and de-energizing in the subsequent range of the angle of 15°). An appropriate operated object is additionally provided on the shaft 23 or coupled therewith. The control circuit 35 is given a rotary position detecting signal of the rotary encoder 25.

In the state shown in FIGS. 1 and 2, the electromagnet 26 remains de-energized. In this state, the pressing member 32 is pressed and urged toward the center of the valley of the concave portion 28 of the rotation detention receiving member 27 so that the attracted member 30 is rotatable around the shaft 23. From this state, if the operator rotates the operating member 24 in a direction of arrow A (FIG. 2), the shaft 23, rotation detention receiving member 27 and disk 25a rotate integrally. In this case, as described above, since the pressing member 32 is pressed and urged toward the center of the valley of the concave portion 28 of the rotation detention receiving member 27 and the attracted member 30 is rotatable around the shaft 23, the pressing member 32 also rotates integrally. Namely, when the electromagnet 26 is de-energized, with the operation of rotating the operating member 24, both rotation detention receiving member 27 and a detention giving unit 29 rotate. Thus, a click feeling does not occur.

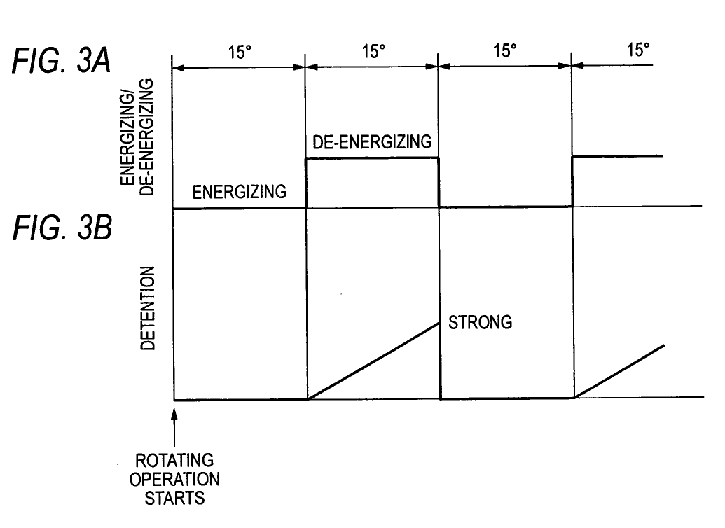

The control circuit 35 detects the start of the rotating operation of the operating member 24 by a signal from the rotary encoder 25. When the control unit 35 detects that the operating member 24 has rotated by the angle of 15° from its operating start, the electromagnet 26 is energized (FIG. 3A). Owing to this energizing, the electromagnet 26 securely attracts or sucks the opposite attracted 30b of the attracted member 30.

Thus, the pressing member 32 is fixed in a non-rotating state. The rotation detention receiving member 27 successively undergoes the rotation operating force so that it is rotated in the direction of arrow A. At this time, the slope 28a of the concave portion 28 of the rotation detention receiving member 27 comes in slidable contact with the pressing member 32 so that the spring force of the coil spring 31 in the pressing direction increases. Thus, the operator gradually strongly feels the rotation detention for the rotation detention receiving member 27 (FIG. 3B). The electromagnet 26 is energized until the rotation of the angle of 15° of the operating member 24 is detected and then de-energized. Owing to this de-energizing, the pressing member 32 returns to the valley center of the slope 28a so that the rotation detention disappears. At this time, the click feeling is given to the operator. The de-energization is continued until the subsequent angle of 15° is detected.

As understood from the above description, in accordance with this embodiment, by changing the predetermined rotary position which is the timing of energizing and de-energizing the electromagnet 26, the clicking angle can be easily changed. Further, by setting the sloping angle formed by the coil spring 31 and the concave portion 28, the interval in which the click feeling is given and its strength can be easily set.

Further, in accordance with this embodiment, the setting device to be operated by the operator is provided and on the basis of the operation of the setting device, the control circuit 35 changes the energizing/de-energizing pattern for the electromagnet 26. For this reason, the clicking angle can be changed arbitrarily, thereby giving excellent convenience.

Additionally, in this embodiment, of the rotation detention receiving member 27 and the detention giving unit 29, as regards the rotation detention receiving member 27, it is rotatable integrally to the operating member 24; and as regards the detention giving unit 29, while the electromagnet 26 is de-energized, it rotates integrally to the operating member 24 whereas while the electromagnet 26 is energized, it is attracted by the electromagnet 26 so that it is fixed in the non-rotating state. However, as regards the detention giving unit 29, it may be rotatable integrally to the operating member 24, and as regards the rotation detention receiving member 27, while the electromagnet 26 is de-energized, it may rotate integrally to the operating member 24 whereas while the electromagnet 26 is energized, it may be attracted by the electromagnet 26 so that it is fixed in the non-rotating state.

Further, the angle range of energizing and de-energizing of the electromagnet 26 should not be limited to 15° described above. In addition, the angle range of energizing may not be equal to the angle range of de-energizing. Further, the position detector should not be limited to the rotary encoder, but may be a plurality of limit switches arranged at predetermined angles and can be modified in various manners. Further, this invention can be widely applied to the operating devices other than the operating device for a heater control switch in a motor car.

What is claimed is:

1. A detent device comprising:
an operating member rotatably attached to a device base;
a rotation detention receiving member;
a detention giving unit that includes a coil spring and a pressing member which is pressed against the concave portion by spring force of the coil spring to give rotation detention thereto;
an electromagnet arranged on the device base;
a position detector that detects a rotary position of the operating member; and
a controller that controls energization of the electromagnet according to the rotary position of the operating member detected by the position detector,
wherein one of the rotation detention receiving member and the detention giving unit is rotatable integrally with the operating member, and the other of the rotation detention receiving member and the detention giving unit is rotatable integrally to the operation member when the electromagnet is de-energized, and is attracted by the electromagnet so as to be fixed in a non-rotating state when the electromagnet is energized.

2. The detent device according to claim 1 further comprising a setting device operated by an operator, wherein the controller changes an energizing/de-energizing pattern for the electromagnet on the basis of the operation of the setting device.
